(19) United States
(12) Patent Application Publication
(10) Pub. No.: US 2025/0335830 A1
(43) Pub. Date: Oct. 30, 2025

(54) TECHNIQUES FOR SUPPORTING MODEL REGISTRIES AND MODEL ENSEMBLE DETERMINATION

(71) Applicant: Red Hat, Inc., Raleigh, NC (US)

(72) Inventors: Robert J. GEADA, Newcastle Upon Tyne (GB); Rui M. Cardoso De Freitas Machado VIEIRA, Newcastle Upon Tyne (GB)

(21) Appl. No.: 18/649,156

(22) Filed: Apr. 29, 2024

(51) Int. Cl. G06N 20/20

(52) U.S. Cl. CPC G06N 20/20

(57) ABSTRACT

Uploaded data including an artificial intelligence (AI) model and metadata associated with the AI model may be received. A task corresponding to the AI model may be determined. A processing device may confirm the metadata includes samples predictions generated based on benchmark data associated with the task corresponding to the AI model. The AI model and the sample predictions may be stored in an AI model registry in response to confirming the metadata includes the sample predictions generated based on the benchmark data associated with the task corresponding to the AI model.

### TECHNICAL FIELD

Aspects of the present disclosure relate to techniques for supporting model registries and model ensemble determinations and, more particularly, to supporting model registries and model ensemble determinations using sample predictions.

### BACKGROUND

A registry may refer to a catalog and/or repository of things related to an activity. For example, a model registry may refer to a repository of artificial intelligence (AI) models related to performing various tasks. Oftentimes, a model registry may include a service to catalog AI models for later retrieval and deployment. Model registries may include per-model metadata, such as the intended task (e.g., classification, object detection, regression, etc.) and the dataset used for training. Model registries may be utilized for crowd-sourcing higher performing models. For example, rather than designing a training a new model for a given task, a pre-made model can be obtained from a registry.

An ensemble may refer to a collection of models utilized for a task and ensembling may refer to a process of aggregating multiple model predictions for the task. Ensembling may utilize a voting process in which each model is asked for a prediction, and the majority predictions is chosen as the final answer. Oftentimes, ensembling can smooth over idiosyncrasies in individual models while strengthening patterns common amongst different models. Thus, an ensemble may provide better robustness and accuracy than individual models.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the scope of the described embodiments.

To easily identify the discussion of any particular element or act, the most significant digit or digits in a reference number refer to the figure number in which that element is first introduced.

FIG. 1 illustrates an exemplary operating environment of an extension for supporting a model registry and model ensemble determination, according to some embodiments of the present disclosure.

FIG. 2 illustrates a process flow for storing a model in conjunction with sample predictions in a model registry according to some embodiments of the present disclosure.

FIG. 3 illustrates a process flow for generating a suggested ensemble according to some embodiments of the present disclosure.

FIG. 4 illustrates a flow diagram of a method for supporting model registries according to some embodiments of the present disclosure.

FIG. 5 illustrates a block diagram of an example system for supporting model registries according to some embodiments of the present disclosure.

FIG. 6 illustrates a block diagram of an example system, according to some embodiments of the present disclosure.

### DETAILED DESCRIPTION

The following description sets forth numerous specific details such as examples of specific systems, components, methods, and so forth, in order to provide a good understanding of various embodiments of the techniques described herein for supporting model registries and model ensemble determination. It will be apparent to one skilled in the art, however, that at least some embodiments may be practiced without these specific details. In other instances, well-known components, elements, or methods are not described in detail or are presented in a simple block diagram format in order to avoid unnecessarily obscuring the techniques described herein. Thus, the specific details set forth hereinafter are merely exemplary. Particular implementations may vary from these exemplary details and still be contemplated to be within the scope of the present disclosure.

Registries provide the ability to store collections of AI models and make them available to others for performing tasks. However, existing model registries fail to enable efficient and accurate techniques to compare performance of different models. For example, existing model registries may include metadata describing attributes and properties of each model. However, these attributes and properties do not enable complementary models to be readily identified, such as for ensembling, resulting in suboptimal model selection and poor task performance. Adding further complexity, existing model registries fail to provide a uniform metric for comparing performance of different models. However, without an available uniform metric to compare models, identification of complimentary combinations of models for ensembling is exceedingly slow and requires excessive compute resources. These limitations can drastically reduce the capabilities of model registries as well as the efficiency of ensembling, contributing to excessive resources demands, under performing ensembles, poor user experiences, and systems, devices, and techniques with limited capabilities.

Accordingly, many embodiments disclosed hereby provide various techniques and features for supporting model registries and model ensemble determination. More specifically, various embodiments, provide a model registry with an available uniform metric for efficient and accurate performance comparisons between different models. For example, each model stored to the model registry may include a set of sample predictions that provide a uniform metric. In a further example, embodiments may determine benchmark data for various tasks and/or sub-tasks and require models to include sample predictions generated based on the benchmark data for the task corresponding to the model. Additionally, many embodiments include tools for utilizing the uniform metric to automatically suggest ensembles. For example, an ensemble selector may readily utilize the sample predictions to compare the performance of models in the registry and identify complimentary models for a task. Further, ensemble determination may be customized based on particular requirements that go beyond performance considerations. For example, resource demands and compute times may be considered in ensemble determinations. In a further example, resource demands and compute times may be assigned different weights based on user input. Accordingly, embodiments described hereby provide tools for identifying and suggesting model ensembles in an efficient, accurate, and customizable manner. In several embodiments, these techniques and features may be implemented via a model registry extension.

In these and other ways, components/techniques described hereby may provide many technical advantages for supporting model registries and ensemble determination. For example, a model registry that includes a uniform metric for readily comparing models may be provided. In another example, complementary models may be automatically identified and optimal ensembles may be suggested to users in an efficient and reliable manner. In yet another example, ensembles may be customized based on particular user requirements and/or objectives. In yet another example, the techniques and features disclosed hereby can result in a positive feedback loop that improves the contents and usability of the AI model registry by providing users with suggested ensembles that improve performance of a task, which can encourage users to upload more models, and more models enable better ensembles. Therefore, the computer-based techniques of the current disclosure improve the functioning of registries for AI models and ensemble determinations, resulting in better user experiences and improved capabilities as compared to conventional approaches. Further, embodiments disclosed hereby can be practically utilized to improve the functioning of a computer and/or to improve a variety of technical fields including model registries, ensemble determinations, ensembling, and crowdsourcing of models.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

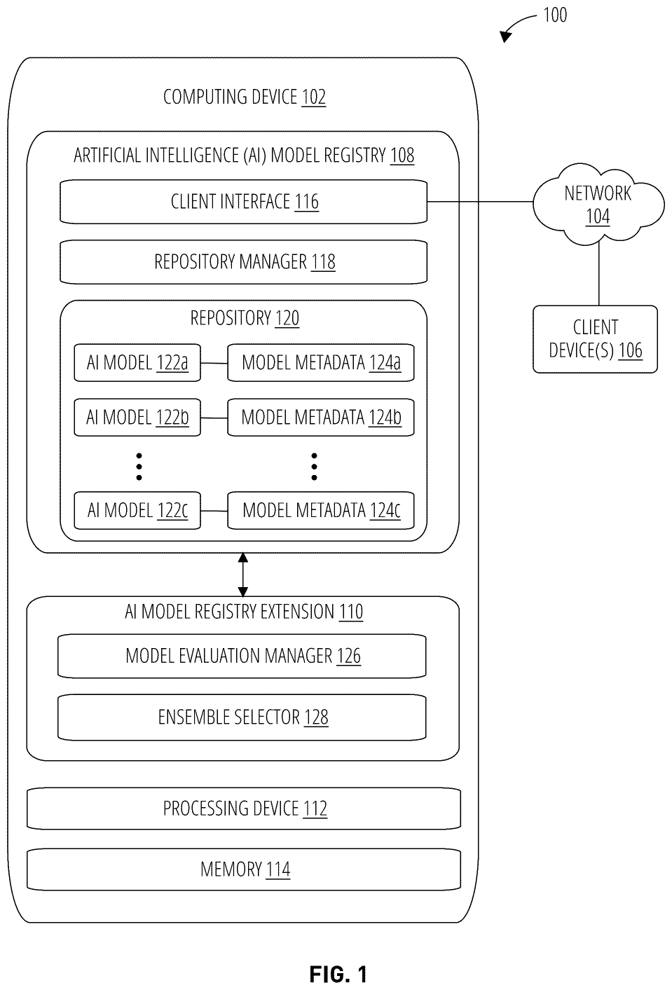

FIG. 1 illustrates an operating environment 100 of an extension for supporting an AI model registry and ensemble determination according to some embodiments. Operating environment 100 includes a computing device 102 communicatively coupled to one or more client devices 106 via a network 104. The computing device 102 includes an artificial intelligence (AI) model registry 108, an AI model registry extension 110, a processing device 112, and a memory 114. The AI model registry 108 may include a client interface 116, a repository manager 118, and a repository 120. The repository 120 may include one or more AI models 122a, 122b, 122c (collectively referred to as AI models 122) and a corresponding one or more instances of model metadata 124a, 124b, 124c (collectively referred to as model metadata 124). In various embodiments, the AI model registry extension 110 may operate to provide the AI model registry 108 with advantageous and reliable features to improve services and capabilities provided by the AI model registry 108. In the illustrated embodiment, the AI model registry extension 110 includes a model evaluation manager 126 and an ensemble selector 128. One or more components of FIG. 1 may be the same or similar to one or more other components disclosed hereby. Further, aspects discussed with respect to various components in FIG. 1 may be implemented by one or more other components from one or more other embodiments without departing from the scope of this disclosure. For example, the repository 120 may be external to the computing device 102 without departing from the scope of this disclosure. Embodiments are not limited in this context.

Generally, the AI model registry 108 may operate to store a collection of AI models (e.g., AI models 122) in conjunction with model metadata (e.g., model metadata 124) in the repository 120. In one embodiment, the AI model registry 108 may include a Red Hat™ OpenShift™ AI model registry. The client interface 116 may enable client devices client device 106 to interact with the AI model registry 108, such as via the network 104. In some embodiments, client interface 116 may provide a graphical user interface (GUI) for interacting with client device 106. The repository manager 118 may be responsible for generating, updating, maintaining, storing data to, and retrieving data from the repository 120. The repository 120 may include a data store for storing models and corresponding metadata.

Embodiments disclosed hereby provides various techniques and features for supporting model registries and model ensemble determination, such as via AI model registry extension 110. Several embodiments, provide a model registry with an available uniform metric for efficient and accurate performance comparisons between different models. For example, each of the plurality of AI models 122 stored to the repository 120 of AI model registry 108 may include a set of sample predictions in the corresponding model metadata 124 that provide the uniform metric. In a further example, embodiments may determine benchmark data for various tasks and require that models include (e.g., be uploaded or provided with) sample predictions generated based on the benchmark data for the task corresponding to the model. Many of the techniques and features disclosed hereby can result in a positive feedback loop that improves the contents and usability of the AI model registry 108. For example, ensemble suggestions can provide users with better model performance and users getting better model performance by using the AI model registry 108 can encourage them to upload more models to the AI model registry 108, resulting in even better suggested ensembles.

Many embodiments include tools for utilizing the uniform metric to automatically suggest ensembles. For example, ensemble selector 128 may readily utilize the sample predictions to compare the performance of models in the registry and identify complimentary models for a task. Further, ensemble determination may be customized based on particular requirements that go beyond performance considerations. For example, one or more of architectural statistics of the model, size of the model, resource requirements, a video random access memory (VRAM) requirements, task it was trained over, sort of data it was trained on, performance on benchmark tasks, performance on benchmark data, information regarding the sample predictions (e.g., how long it took the model to generate each of the predictions and/or did any of the predictions take longer than the others), and the like may be utilized to make ensemble determinations. In some embodiments, one or more of these considerations may be assigned different weights, such as based on user input, when determining a suggested ensemble.

In many embodiments, the AI model registry extension 110 may provide additional features and functionalities, such as the ones discussed above, to the AI model registry 108 and/or components thereof that improve the functionality, capabilities, performance, and/or efficiency of the AI model registry 108. In various embodiments, the AI model registry extension 110 may control and/or direct one or more operational aspects of components of the AI model registry 108. For example, the model evaluation manager 126 of AI model registry extension 110 may prevent repository manager 118 from storing a model in the repository 120 without including corresponding metadata with appropriate sample predictions. In another example, the ensemble selector 128 may generate suggested ensembles based on sample predictions included in model metadata 124. More generally, each instance of model metadata 124 may include information regarding a corresponding model. For example, each instance of model metadata 124 may include information such as architectural statistics of the model, size of the model, resource requirements, a video random access memory (VRAM) requirements, task it was trained over, sort of data it was trained on, performance on benchmark tasks, performance on benchmark data, and the like. In some embodiments, each instance of model metadata may include information regarding the sample predictions. For example, how long it took the model to generate each of the predictions and/or did any of the predictions take longer than the others. Some embodiments may require that a model include (e.g., be uploaded or provided with) one or more of the items of information. For example, the model evaluation manager 126 of AI model registry extension 110 may prevent repository manager 118 from storing a model in the repository 120 without including required items of information in model metadata 124. In other embodiments, the one or more items of information (including the sample predictions) may be generated by the model registry 108 and/or AI model registry extension 110. For example, in some embodiments, the model registry 108 and/or AI model registry extension 110 may automatically generate the items of information or any missing items of information for an AI model in response to the AI model being uploaded.

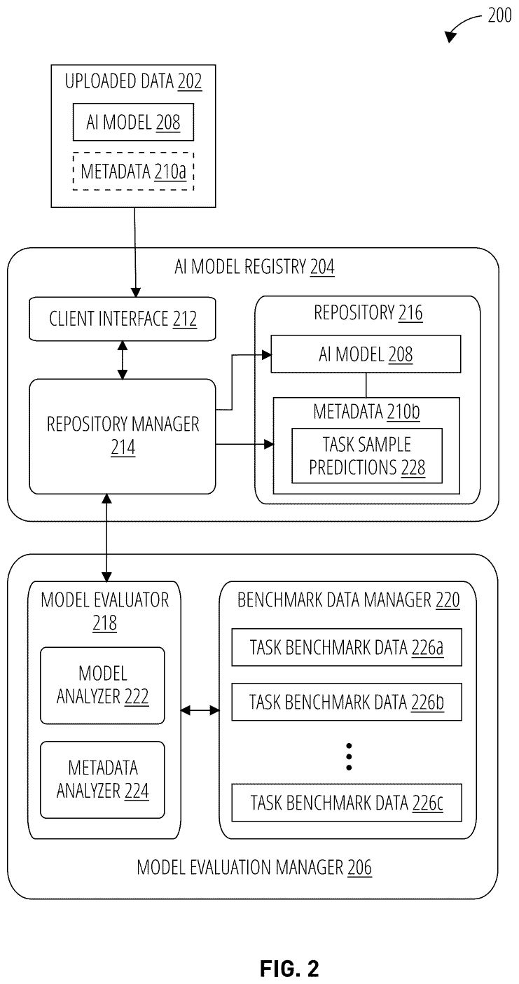

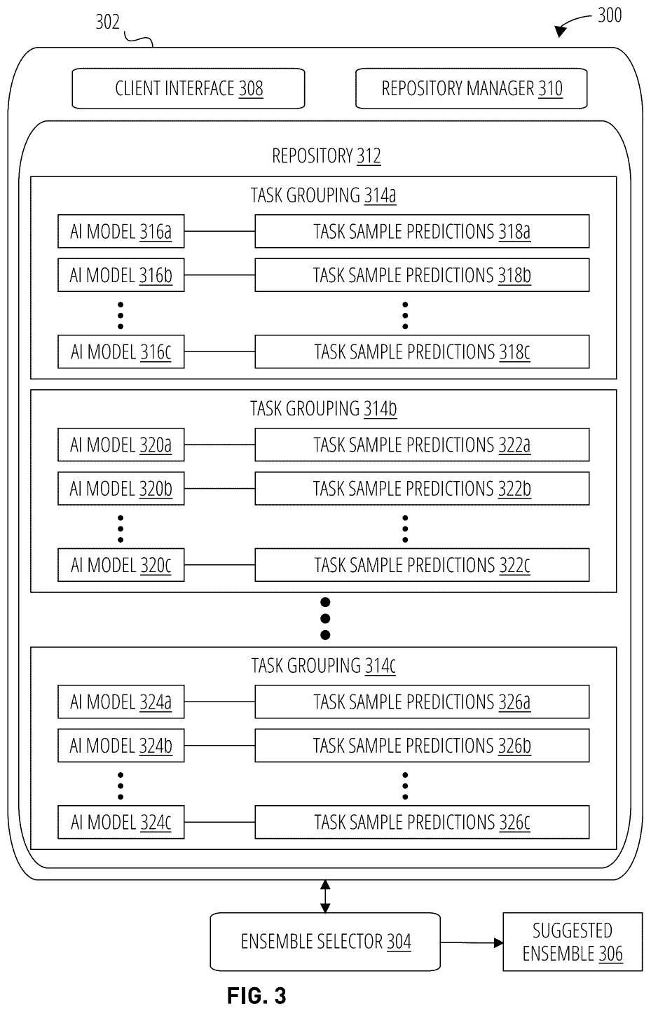

In various embodiments, one or more components of the AI model registry extension 110 may request and/or present data from/to a client device via the client interface 116. For example, model evaluation manager 126 may request metadata, such as a corresponding task or sample predictions, be provided in conjunction with an AI model. In another example, suggested ensembles generated by ensemble selector 128 may be presented to a client device via client interface 116. Aspects of the model evaluation manager 126 are described in more detail below, such as with respect to FIG. 2. Aspects of the ensemble selector 128 are described in more detail below, such as with respect to FIG. 3.

It should be noted that although a single processing device 112 and a single memory 114 is depicted in FIG. 1 for simplicity, other embodiments may include multiple processing devices, storage devices, or devices. Processing device 112 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 112 may also include one or more special-purpose processing devices such as an application specific integrated circuit (ASIC), a field programmable gate array (FPGA), a digital signal processor (DSP), network processor, or the like. Further details regarding supporting AI model registries and ensemble determinations will be discussed below.

FIG. 2 illustrates a process flow 200 for storing a model in conjunction with sample predictions in a model registry according to some embodiments. For example, process flow 200 may support storing an AI model 208 in an AI model registry 204 in conjunction with task sample predictions 228 by providing features that confirm the presence of the appropriate task sample predictions before allowing the AI model 208 to be stored in the AI model registry 204. One or more components of FIG. 2 may be the same or similar to one or more other components disclosed hereby. For example, AI model registry 204, or one or more components thereof, may be the same or similar to AI model registry 108, or one or more components thereof. In another example, model evaluation manager 206 may be the same or similar to model evaluation manager 126. Further, aspects discussed with respect to various components in FIG. 2 may be implemented by one or more other components from one or more other embodiments without departing from the scope of this disclosure. For example, model evaluation manager 206 may be implemented by AI model registry extension 110 without departing from the scope of this disclosure. In another example, model evaluation manager 206 may be included in AI model registry 204 without departing from the scope of this disclosure. Embodiments are not limited in this context.

The illustrated embodiment includes uploaded data 202, AI model registry 204, and model evaluation manager 206. The uploaded data 202 may include the AI model 208 and, optionally, metadata 210a. The AI model registry 204 may include a client interface 212, a repository manager 214, and a repository 216. The model evaluation manager 206 may include a model evaluator 218 and a benchmark data manager 220. The model evaluator 218 may include a model analyzer 222 and a metadata analyzer 224. The benchmark data manager 220 may include a plurality of instances of task benchmark data 226a, 226b, 226c.

As discussed in more detail below with respect to FIG. 3, the repository 216 may include a plurality of AI models and each AI model in the repository 216 may be associated with one or more tasks. The tasks may be utilized for grouping various AI models based on one or more parameters, such as purpose, training data, type/format/semantics of input data, type/format/semantics of output data, etc. In many embodiments, the tasks may have a hierarchical structure. For example, a task may be object classification, a sub-task of the task may be object classification in self-driving cars, and the sub-task may be further divided into pedestrian identification and road sign identification. Additionally, each task, sub-task, etc. may be associated with different sets of benchmark data.

Referring to process flow 200, AI model registry 204 may initially receive uploaded data 202 via client interface 212. For example, uploaded data 202 may be provided by a client device. In various embodiments, the uploaded data 202 may include an AI model 208. In various such embodiments, the uploaded data 202 may additionally include metadata 210a associated with the AI model 208. In some embodiments, inclusion of metadata 210a may be optional. For instance, in various embodiments, the model evaluation manager 206 may generate the task sample predictions instead of requiring the task sample predictions to be generated and provided to the AI model registry 204. In such embodiments, the uploaded data 202 may not include metadata 210a or the uploaded data 202 may include metadata 210a without task sample predictions.

In many embodiments, the uploaded data 202 may include responses to one or more prompts presented on the client device. For example, model evaluation manager 206 may cause client interface 212 to present a GUI on the client device that requests user input regarding one or more characteristics of the AI model, such as the corresponding task. In other examples, the task corresponding to the AI model 208 may be determined by model analyzer 222, such as based on the output produced by AI model 208. In one embodiment, the one or more prompts may request various items of data as part of an interface flow for uploading new models to the repository 216. For example, a first step may request the AI model to be uploaded, a second step may request the task corresponding to the AI model, and a third step may request the sample predictions to be uploaded. In such examples, in response to the appropriate sample predictions failing to be uploaded, the appropriate benchmark data may be provided to the client device. In some embodiments, a downloadable bundle may be made available to client devices, such as via client interface 212. The downloadable bundle may include the benchmark data for generating the sample predictions.

Referring back to process flow 200, once the uploaded data 202 is received by AI model registry 204, the uploaded data 202 may be evaluated by model evaluation manager 206. It will be appreciated that model evaluation manager 206 may form part of an AI model registry extension. The evaluation of the uploaded data 202 may be performed by model analyzer 222 and/or metadata analyzer 224 of model evaluator 218. For example, metadata analyzer 224 may confirm whether or not the metadata 210a includes the appropriate task sample predictions. In other words, the metadata analyzer 224 may validate that sample predictions included in metadata 210a were generated based on the appropriate one of task benchmark data 226a, 226b, 226c.

Benchmark data manager 220 may generate and/or maintain benchmark data for each task that corresponds to a model. For example, each instance of benchmark data may include between 500 and 10000 data points that result in between 500 and 10000 sample predictions by a model. In various embodiments, a task may refer to a combination of data and intended model output. Further, a different set of benchmark data may be determined for each task, sub-task, etc. In various embodiments, benchmark data may be generated based on training data. For example, the training data may be publicly available, such as for an open source model. Accordingly, the benchmark data manager 220 may generate benchmark data sets based on the publicly available training data. In one embodiment, the benchmark data manager 220 may automatically obtain the training data set, such as from the internet.

In many embodiments, techniques may be utilized to ensure benchmark data sets provide a representative sample that is diverse. For example, cross-validation may be utilized in determining benchmark data sets to prevent over-fitting. In such an example, 900 of 1000 data points in a benchmark data set may be utilized to choose the ensemble and the remaining 100 data points may be utilized to validate the ensemble, then the procedure may be repeated a number of times with different 900 of the 1000 data points for ensemble selection and the different remaining 100 for validation. In many embodiments, different benchmark data sets may be derived from the same set of training data. For example, benchmark data for object recognition may be determined from a set of training data and benchmark data for pedestrian identification may be determined from a subset of the set of training data specifically relevant to pedestrian identification. In various embodiments, benchmark data may be viewed and/or modified via client interface 212. In some embodiments, benchmark data manager 220 may generate one or more target characteristics for sample predictions generated based on each instance of benchmark data.

In various embodiments, the appropriate benchmark data, or characteristics of sample predictions generated based on the appropriate benchmark data, may be identified based on the task corresponding to the AI model 208. The metadata analyzer 224 may utilize the appropriate benchmark data and/or characteristics of sample predictions generated based on the appropriate benchmark data to determine whether sample predictions included in metadata 210a were generated based on the appropriate benchmark data. For example, one or more characteristics (e.g., count, format, content, etc.) of the sample predictions or indicators (e.g., a unique identifier of the benchmark data included with the sample predictions) may enable the metadata analyzer 224 to confirm that the sample predictions were generated based on the appropriate task benchmark data. Once the AI model 208 and corresponding task sample predictions are evaluated and the sample predictions are confirmed, the AI model 208 may be stored in the repository 216 in conjunction with metadata 210b including the task sample predictions 228. In many embodiments, metadata 210b may include additional metadata, such as resource demands and/or compute time of the AI model 208.

In many embodiments, the model evaluation manager 206 may perform one or more additional validations of the uploaded data 202 prior to storing AI model 208 in repository 216. For example, model analyzer 222 may analyze the AI model 208 for malicious code or evidence that it is stolen (e.g., by checking a watermark). In another example, the metadata analyzer 224 may analyze the metadata 210a for malicious code or incorrect data. For example, metadata analyzer 224 may verify a task corresponding to the AI model 208 included in 210a is accurate, such as based on the format of the sample predictions.

FIG. 3 illustrates a process flow 300 for generating a suggested ensemble according to some embodiments. For example, process flow 300 may support generating a suggested ensemble 306 by providing features that identify complementary models based on task sample predictions stored with each AI model in an AI model registry 302. One or more components of FIG. 3 may be the same or similar to one or more other components disclosed hereby. For example, AI model registry 302, or one or more components thereof, may be the same or similar to AI model registry 108, or one or more components thereof. In another example, ensemble selector 304 may be the same or similar to ensemble selector 128. Further, aspects discussed with respect to various components in FIG. 3 may be implemented by one or more other components from one or more other embodiments without departing from the scope of this disclosure. Embodiments are not limited in this context.

The illustrated embodiment includes AI model registry 302, ensemble selector 304, and suggested ensemble 306. The AI model registry 302 includes a client interface 308, a repository manager 310, and a repository 312. The repository 312 includes a plurality of AI models and corresponding sample predictions grouped by task. More specifically, the repository 312 includes one or more task groupings 314a, 314b, 314c (collectively referred to as task groupings 314). The task grouping 314a includes one or more AI models 316a, 316b, 316c (collectively referred to as AI models 316) and a corresponding one or more sets of task sample predictions 318a, 318b, 318c (collectively referred to as task sample predictions 318). The task grouping 314b includes one or more AI models 320a, 320b, 320c (collectively referred to as AI models 320) and a corresponding one or more sets of task sample predictions 322a, 322b, 322c (collectively referred to as task sample predictions 322). The task grouping 314c includes one or more AI models 324a, 324b, 324c (collectively referred to as AI models 324) and a corresponding one or more sets of task sample predictions 326a, 326b, 326c (collectively referred to as task sample predictions 326).

The AI models in the repository 312 may be grouped by task. In many embodiments, the tasks may have a hierarchical structure of groupings with one or more tasks, sub-tasks, etc. and models may belong to one or more of the groupings. The tasks may be utilized for grouping various AI models based on one or more parameters, such as purpose, training data, type/format/semantics of input data, type/format/semantics of output data, etc. For example, a task may be object classification, a sub-task of the task may be object classification in self-driving cars, and the sub-task may be further divided into pedestrian identification, road sign identification, and road marking identification. In another example, a task grouping may correspond to output taxonomy. In such an example, all models associated with a specific task may utilize the same classification identifiers (e.g., Class 35 corresponds to identifying a dog, Class 36 corresponds to identifying a cat, etc.) Further, as previously discussed, each grouping may be associated with different sets of benchmark data for generating sample predictions related to the corresponding grouping.

Referring to process flow 300, the ensemble selector 304 may utilize the task sample predictions associated with each AI model to identify complementary AI models. Further, the ensemble selector 304 may generate a suggested ensemble 306 based, at least in part, on the complementary AI models. For example, ensemble selector 304 may aggregate multiple models together and have them collectively vote on their prediction, which can smooth over individual weaknesses of the individual models and result in performance that is better than the sum of its parts. In various embodiments, ensemble selector 304 may utilize one or more ensemble selection algorithms and/or ensemble selection AI models, such as hill-climbing or a machine learning model. Advantageously, the ensemble selector 304 can determine the suggested ensemble 306 based on the sample predictions without having to perform any inferences, making ensemble determination faster and more efficient. Further, instead of saving the benchmark data accessorily for each model, just the sample predictions are saved, which reduces the size of the repository 312 and improves efficiency.

In many embodiments, the ensemble selector 304 may consider factors in addition to the sample predictions in determining the suggested ensemble 306. Thus, ensemble determination may be customized based on particular requirements that go beyond performance considerations. For example, one or more of resource demands, compute times, efficiency, response time, best performance with minimum number of computer nodes, most brute performance, and the like, may be considered in ensemble determinations. In a further example, the different considerations may be assigned different weights, such as based on user input, when determining a suggested ensemble.

In various embodiments, the suggested ensemble 306 may be presented for selection via client interface 308. In some embodiments, multiple suggested ensembles may be presented for selection. For example, a first suggested ensemble that minimizes compute resources and a second suggested ensemble that maximizes performance may be presented via client interface 308 for user selection. Alternatively, if the suggested ensemble 306 is rejected, a single model may be utilized. In some embodiments, various comparison metrics may be provided the single model and/or suggested ensembles. For example, accuracy for the single model versus the suggested ensembles may be provided. Additionally, customization of the ensemble selection may be performed based on input received via client interface 308. For example, a GUI may be provided via client interface 308 that enables a user to customize weights and factors utilized in determining a suggested ensemble.

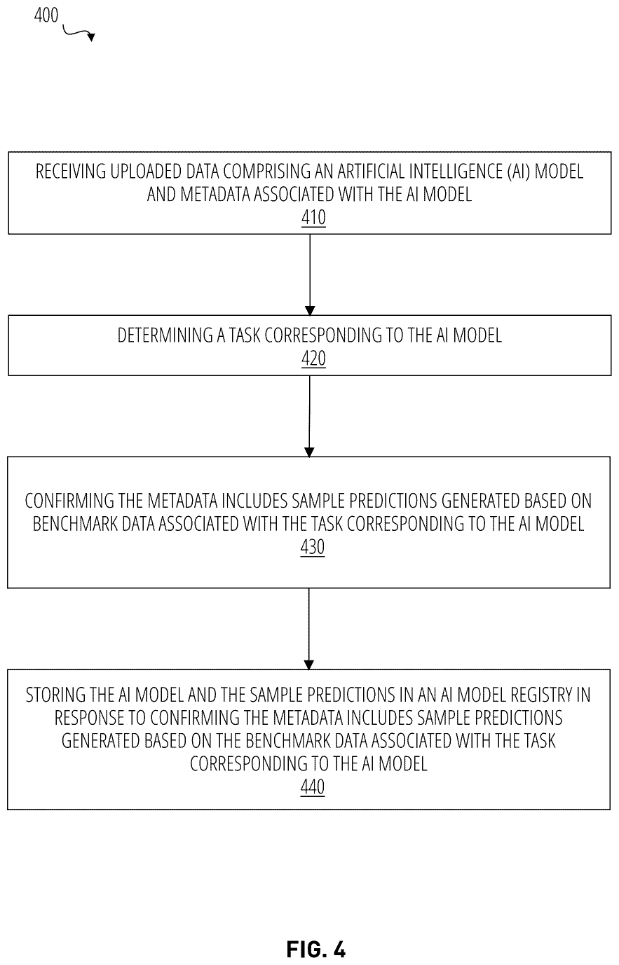

FIG. 4 is a flow diagram of a method 400 of for supporting model registries according to some embodiments. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed through the execution of AI model registry extension 110 by processing device 112 of FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic received uploaded data comprising an AI model and metadata associated with the AI model. For example, uploaded data 202 including AI model 208 and metadata 210a may be received via the client interface 212 of AI model registry 204. In some embodiments, the uploaded data 202 may be received from a client device via a network.

At block 420, the processing logic determines a task corresponding to the AI model. For example, model evaluator 218 may determine a task corresponding to the AI model 208. In some embodiments, the task corresponding to the AI model may be determined by analyzing the AI model, such as with model analyzer 222. In additional, or alternative, embodiments, the task corresponding to the AI model may be determined by analyzing the metadata provided with the AI model, such as with metadata analyzer 224. In one embodiment, the task corresponding to the AI model 208 may be determined based on user input, such as user input provided as part of a model intake flow. For example, the model evaluation manager 206 may cause a series of questions regarding the AI model to be presented in a GUI via the client interface 212. One or more of these questions may be utilized to identify the task corresponding to the AI model.

Proceeding to block 430, the processing logic may confirm the metadata includes sample predictions generated based on benchmark data associated with the task corresponding to the AI model. For example, metadata analyzer 224 of model evaluator 218 may confirm that metadata 210a includes task sample predictions and that the task sample predictions were generated based on the appropriate benchmark data. In some embodiments, the metadata analyzer 224 may utilize the task corresponding to the AI model 208 to determine the appropriate task benchmark data as task benchmark data 226b and then confirm that the sample predictions included in metadata 210a were generated based on the task benchmark data 226b. In many embodiments, the metadata analyzer 224 confirms that the sample predictions were generated based on the appropriate task benchmark data without having to generate a second set of sample predictions. For example, one or more characteristics (e.g., count, format, content, etc.) of the sample predictions or indicators (e.g., a unique identifier of the benchmark data included with the sample predictions) may enable the metadata analyzer 224 to confirm that the sample predictions were generated based on the appropriate task benchmark data.

Continuing to block 440, the processing logic may store the AI model and the sample predictions in an AI model registry in response to confirming the metadata includes sample predictions generated based on the benchmark data associated with the task corresponding to the AI model. For example, AI model 208 and metadata 210b including task sample predictions 228 may be stored in AI model registry 204 in response to model evaluator 218 confirming the metadata 210a includes the task sample predictions 228 generated based on the task benchmark data 226a.

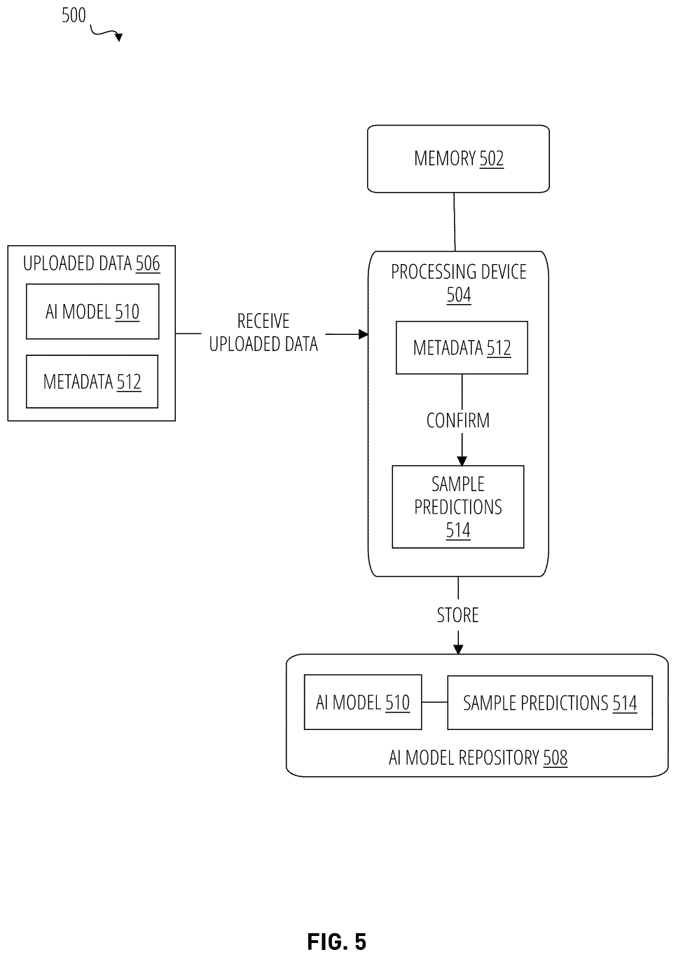

FIG. 5 illustrates a block diagram of a system 500 for supporting model registries according to some embodiments. In the illustrated embodiment, system 500 includes a memory 502, a processing device 504, uploaded data 506, and an AI model repository 508. It should be noted that some components of system 500 are shown for illustrative purposes only and are not physical components of the system 500, such as uploaded data 506, AI model 510, metadata 512, and sample predictions 514. One or more components of FIG. 5 may be the same or similar to one or more other components disclosed hereby. For example, processing device 504 may be the same or similar to processing device 112. Further, aspects discussed with respect to various components in FIG. 5 may be implemented by one or more other components from one or more other embodiments without departing from the scope of this disclosure. For example, AI model repository 508 may be included in memory 502 without departing from the scope of this disclosure. Embodiments are not limited in this context.

In system 500, the processing device 504 may receive uploaded data 506 including AI model 510 and metadata 512. In various embodiments, uploaded data 506 may be received from a client device and/or through user input provided via a client device. For example, one or more portions of metadata 512 may be received as user input provided in response to prompts presented via a GUI. In one such example, a task corresponding to the AI model 510 may be acquired via user input provided in response to prompts presented via a GUI.

In response to receiving uploaded data 506, the processing device 504 may confirm whether or not the metadata 512 includes sample predictions 514 generated based on benchmark data associated with the task corresponding to the AI model 510. For example, the processing device 504 may evaluate the contents of metadata 512 to identify whether it includes any sample predictions. If the metadata 512 does include sample predictions, the processing device 504 may determine whether the sample predictions were generated based on the appropriate benchmark data (i.e., benchmark data associated with the task corresponding to the AI model). For example, the format of the sample predictions may be utilized, at least in part, to determine whether the sample predictions were generated based on the appropriate benchmark data. In some such examples, it may be determined whether the sample predictions semantically match sample predictions generated based on the appropriate benchmark data.

If the sample predictions 514 in metadata 512 are confirmed as being generated based on the appropriate benchmark data, then the processing device 504 may store the AI model 510 and the sample predictions 514 in the AI model repository 508. However, if the sample predictions 514 in metadata 512 are not confirmed as being generated based on the appropriate benchmark data, then the processing device 504 may not store the AI model 510 or the sample predictions 514 in the AI model repository 508. In some embodiments, the processing device 504 may utilize the appropriate benchmark data and the AI model 510 to generate the sample predictions 514 and then store them in AI model repository 508. In other embodiments, the processing device 504 may request the appropriate sample predictions from the client device. Additionally, the processing device 504 may provide the appropriate benchmark data to the client device.

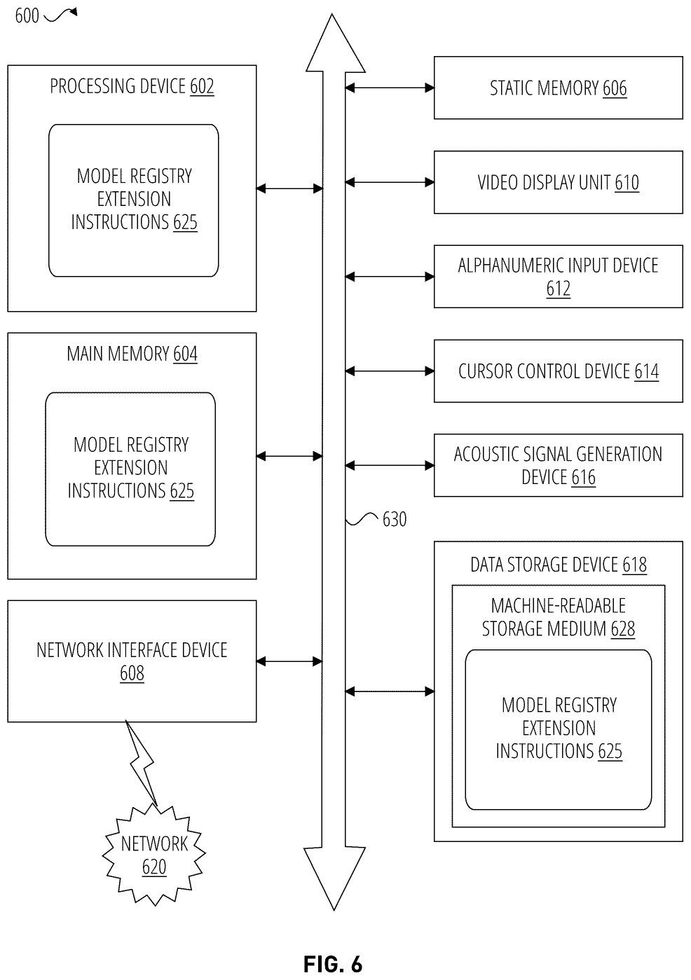

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device 602 (e.g., a general purpose processor, a PLD, etc.), a main memory 604 (e.g., synchronous dynamic random access memory (DRAM), read-only memory (ROM)), a static memory 606 (e.g., flash memory and a data storage device 618), which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may execute the operations described herein, in accordance with one or more aspects of the present disclosure, for performing the operations and steps discussed herein.

Computing device 600 may further include a network interface device 608 which may communicate with a network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In one embodiment, video display unit 610, alphanumeric input device 612, and cursor control device 614 may be combined into a single component or device (e.g., an LCD touch screen).

Data storage device 618 may include a machine-readable storage medium 628 on which may be stored one or more sets of instructions 625 that may include instructions for a component (e.g., one or more components of AI model registry 108 and/or one or more components of AI model registry extension 110) for carrying out the operations described herein, in accordance with one or more aspects of the present disclosure. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While machine-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “receiving,” “determining,” “confirming,” “storing”, “identifying”, “analyzing”, “generating”, or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting. As used herein, the term “and/or” includes any and all combination of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving uploaded data comprising an artificial intelligence (AI) model and metadata associated with the AI model;
determining a task corresponding to the AI model;
confirming, by a processing device, the metadata includes sample predictions generated based on benchmark data associated with the task corresponding to the AI model; and
storing the AI model and the sample predictions in an AI model registry in response to confirming the metadata includes the sample predictions generated based on the benchmark data associated with the task corresponding to the AI model.

2. The method of claim 1, further comprising:
identifying a plurality of AI models stored in the AI model registry, the plurality of AI models associated with the task, and the plurality of AI models including the AI model; and
analyzing the sample predictions for each of the plurality of models associated with the task to determine a suggested ensemble of models for performing the task, wherein the suggested ensemble of tasks includes one or more of the plurality of models.

3. The method of claim 2, further comprising analyzing the sample predictions and additional metadata associated with each of the plurality of models stored in the model registry to determine the suggested ensemble of models for performing the task.

4. The method of claim 3, wherein the additional metadata includes at least one of compute resource requirements for each of the plurality of models, a video random access memory (VRAM) requirement for each of the plurality of models, or compute time for each of the plurality of models.

5. The method of claim 1, wherein the AI model registry includes a set of groupings with each grouping in the set of groupings associated with one of a plurality of tasks, and the method further comprising storing the AI model and the sample predictions in the grouping associated with the task.

6. The method of claim 1, further comprising:
receiving second uploaded data comprising a second AI model;
determining a second task corresponding to the second AI model; and
determining the second uploaded data fails to include second sample predictions generated based on second benchmark data associated with the second task corresponding to the second AI model.

7. The method of claim 6, further comprising:
generating the second sample predictions based on the second benchmark data associated with the second task corresponding to the second AI model; and
storing the second AI model and the second sample predictions in the AI model registry.

8. The method of claim 6, further comprising:
requesting, from a client device, the second sample predictions generated based on the second benchmark data associated with the second task in response to determining the second uploaded data fails to include the second sample predictions generated based on the second benchmark data;
receiving, from the client device, third uploaded data;
confirming the third uploaded data includes the second sample predictions generated based on the second benchmark data associated with the second task; and
storing the second AI model and the second sample predictions in the AI model registry in response to confirming the third uploaded data includes metadata includes the second sample predictions generated based on the second benchmark data associated with the second task.

9. The method of claim 8, further comprising providing the second benchmark data associated with the second task to the client device.

10. A system comprising:
a memory; and
a processing device, operatively coupled to the memory, to:
receive uploaded data comprising an artificial intelligence (AI) model and metadata associated with the AI model;
determine a task corresponding to the AI model;
confirm, by a processing device, the metadata includes sample predictions generated based on benchmark data associated with the task corresponding to the AI model; and
store the AI model and the sample predictions in an AI model registry in response to confirming the metadata includes the sample predictions generated based on the benchmark data associated with the task corresponding to the AI model.

11. The system of claim 10, wherein the processing device is further to:
identify a plurality of AI models stored in the AI model registry, the plurality of AI models associated with the task, and the plurality of AI models including the AI model; and
analyze the sample predictions for each of the plurality of models associated with the task to determine a suggested ensemble of models for performing the task, wherein the suggested ensemble of tasks includes one or more of the plurality of models.

12. The system of claim 11, wherein the processing device is further to analyze the sample predictions and additional metadata associated with each of the plurality of models stored in the model registry to determine the suggested ensemble of models for performing the task.

13. The system of claim 12, wherein the additional metadata includes at least one of compute resource requirements for each of the plurality of models, a video random access memory (VRAM) requirement for each of the plurality of models, or compute time for each of the plurality of models.

14. The system of claim 10, wherein the AI model registry includes a set of groupings with each grouping in the set of groupings associated with one of a plurality of tasks, and the processing device is further to store the AI model and the sample predictions in the grouping associated with the task.

15. The system of claim 10, wherein the processing device is further to:
receive second uploaded data comprising a second AI model;
determine a second task corresponding to the second AI model; and
determine the second uploaded data fails to include second sample predictions generated based on second benchmark data associated with the second task corresponding to the second AI model.

16. The system of claim 15, wherein the processing device is further to:
generate the second sample predictions based on the second benchmark data associated with the second task corresponding to the second AI model; and
store the second AI model and the second sample predictions in the AI model registry.

17. The system of claim 15, wherein the processing device is further to:
request, from a client device, the second sample predictions generated based on the second benchmark data associated with the second task in response to determining the second uploaded data fails to include the second sample predictions generated based on the second benchmark data;
receive, from the client device, third uploaded data;
confirm the third uploaded data includes the second sample predictions generated based on the second benchmark data associated with the second task; and
store the second AI model and the second sample predictions in the AI model registry in response to confirming the third uploaded data includes metadata includes the second sample predictions generated based on the second benchmark data associated with the second task.

18. The system of claim 17, wherein the processing device is further to provide the second benchmark data associated with the second task to the client device.

19. A non-transitory computer-readable storage medium including instructions that, when executed by a processing device, cause the processing device to:
receive uploaded data comprising an artificial intelligence (AI) model and metadata associated with the AI model;
determine a task corresponding to the AI model;
confirm, by the processing device, the metadata includes sample predictions generated based on benchmark data associated with the task corresponding to the AI model; and
store the AI model and the sample predictions in an AI model registry in response to confirming the metadata includes the sample predictions generated based on the benchmark data associated with the task corresponding to the AI model.

20. The non-transitory computer-readable storage medium of claim 19, wherein the processing device is further to:
identify a plurality of AI models stored in the AI model registry, the plurality of AI models associated with the task, and the plurality of AI models including the AI model; and
analyze the sample predictions for each of the plurality of models associated with the task to determine a suggested ensemble of models for performing the task, wherein the suggested ensemble of tasks includes one or more of the plurality of models.
